(19) United States
(12) Patent Application Publication
(10) Pub. No.: US 2020/0106677 A1
(43) Pub. Date: Apr. 2, 2020

(54) DATA CENTER FORECASTING BASED ON OPERATION DATA

(71) Applicant: Hewlett Packard Enterprise Development LP, Houston, TX (US)

(72) Inventor: Umesh Kumar Pathak, Palo Alto, CA (US)

(21) Appl. No.: 16/146,404

(22) Filed: Sep. 28, 2018

(51) Int. Cl. H04L 12/24; G06N 20/00

(52) U.S. Cl. CPC H04L 41/147; H04L 41/16; H04L 41/5054; G06N 20/00; H04L 41/0826; H04L 41/0681; H04L 41/0886

(57) ABSTRACT

In some examples, a method for data center forecasting can include: collecting operation data about a data center, the data including data at the application layer, the operating environment layer, and the infrastructure layer; creating a supervised machine learning model based on the collected data; forecasting expected state, capacity, and growth rate of the data center based on the created model; and performing an automated preemptive action based on the forecast.

### BACKGROUND

The term “data center” can, for example, refer to a facility used to house computer systems and associated equipment, such as networking, processing, and storage systems, as well as software and firmware components. Such a data center can occupy one or more rooms, floors, an entire building, or multiple buildings. Business continuity can be an important consideration for data center administrators. For example, if equipment in a data center become unavailable due to hardware or software failure, company operations may be impaired or stopped completely. As a result, companies often seek solutions for increased infrastructure reliability in order to minimize the chance of such disruption or for other reasons.

### BRIEF DESCRIPTION OF DRAWINGS

FIG. 1 is a flowchart for a method, according to an example.

FIG. 2 is a table depicting example metrics for various components and subcomponents, according to an example.

FIG. 3 is a diagram depicting the use of a machine learning algorithm model, according to an example.

FIG. 4 is a diagram depicting the use of a machine learning algorithm model, according to another example.

FIG. 5 is a diagram of a computing device, according to an example.

FIG. 6 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Data centers are often complex systems that rely not only on a range of hardware equipment, such as servers, storage, and networking equipment, but also software, such as business applications, custom-developed software, databases, Open Source components, hardware and software virtualizations (e.g. containers), operating environments (e.g., Linux, OpenStack), and system management software.

As a result, it can be challenging for data center administrators or other entities to identify potential issues, bottlenecks or expected growth at the system level or other levels of the data center. Making changes to such a system (e.g., expanding the existing system or adding new instances) can often take weeks or even months, especially if new system or infrastructure equipment (e.g. storage, server, networking, or an entire replacement system) is to be ordered from a vendor. As used herein, the term “infrastructure” can, for example, refer to hardware as well as software infrastructure (e.g., applications, firmware, etc.). A lack of understanding and/or timely identification of such issues can lead to significant system downtime, which may lead to millions of dollars in lost revenue, the potential loss of customers, or other consequences. This can become even more important when the system is considered “mission-critical.”

Certain implementations of the present disclosure are directed to an artificial intelligence or supervised machine learning model for predicting expected state, capacity, and/or growth rate of data center equipment, systems, and/or solutions and for taking automated intelligent action to preempt unfavorable consequences. In some implementations, a method can include: (1) collecting operation data about a data center, the data including data at the application layer, the operating environment layer, and the infrastructure layer; (2) creating a supervised machine learning model based on the collected data; (3) forecasting expected state, capacity, and growth rate of the data center (and/or components thereof) based on the created model; and (4) performing an automated preemptive action based on the forecast.

Certain implementations of the present disclosure may allow for various advantages. For example, certain implementations may drastically simplify operations, reduce risk, and/or expedite a decision making process to run a system or solution without significant unplanned downtime by identifying potential growth, bottlenecks, providing intelligence suggestions, and taking intelligent preemptive actions. Other advantages of implementations presented herein will be apparent upon review of the description and figures.

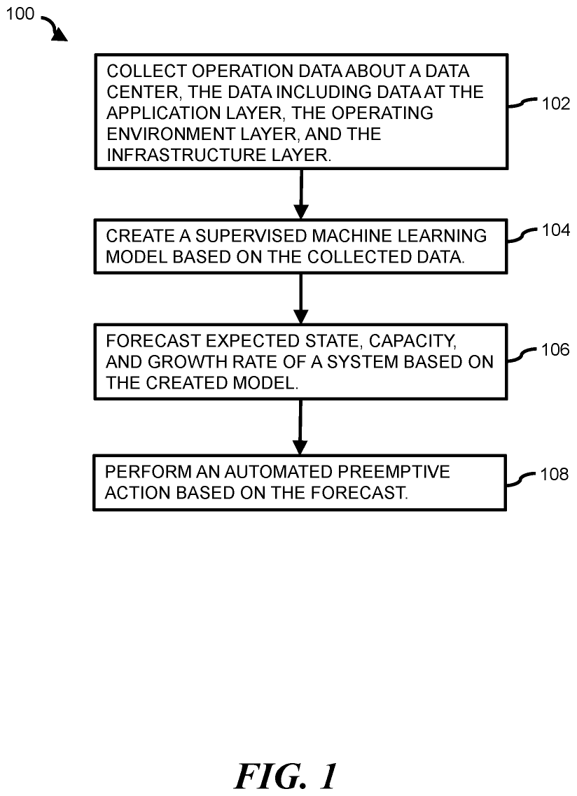

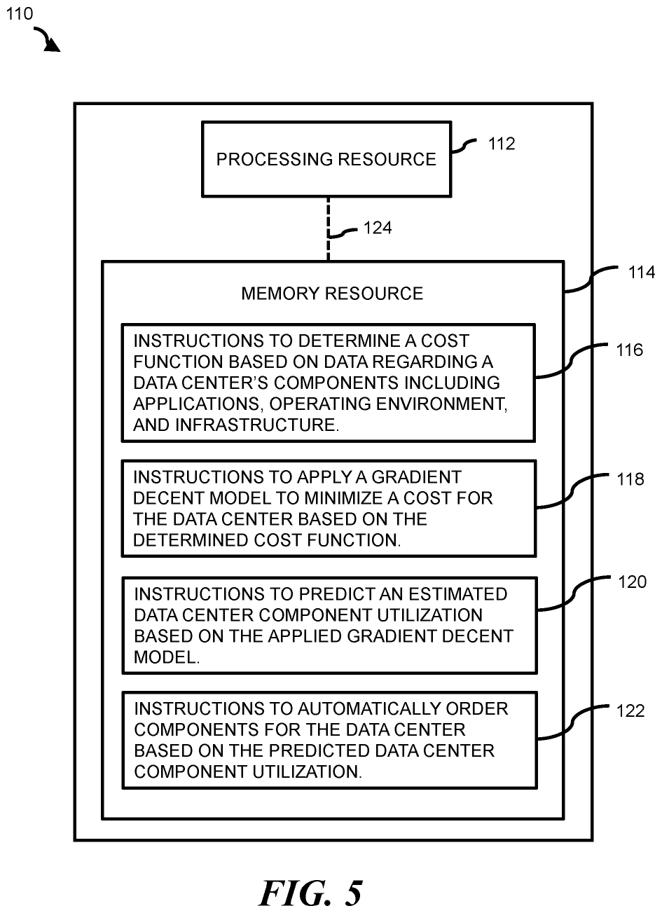

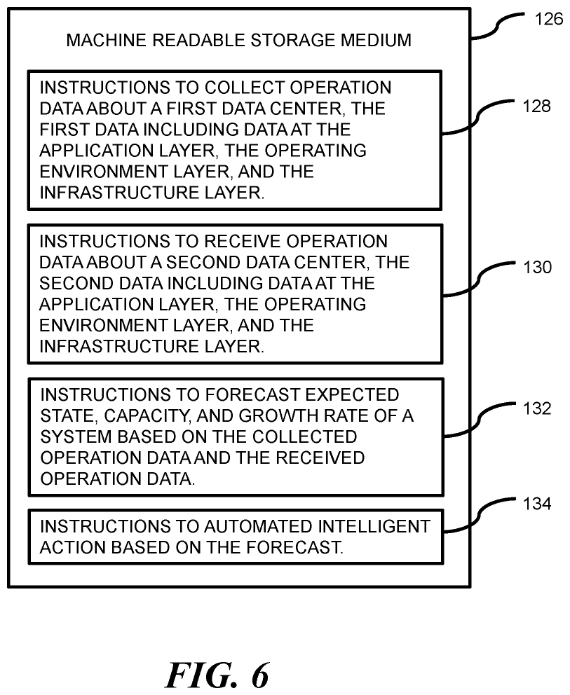

FIG. 1 depicts a flowchart for an example method 100 related to data center forecasting based on operation data, according to an example. In some implementations, method 100 can be implemented or otherwise executed through the use of executable instructions stored on a memory resource (e.g., the memory resource of the computing device of FIG. 5), executable machine readable instructions stored on a storage medium (e.g., the medium of FIG. 6), in the form of electronic circuitry (e.g., on an Application-Specific Integrated Circuit (ASIC)), and/or another suitable form. In some implementations, method 100 can be executed on multiple computing devices in parallel (e.g., in a distributed computing fashion).

Method 100 includes collecting (at block 102) operation data about a data center. The data can, for example, include data at the application layer, the operating environment layer, and the infrastructure layer. Application layer data can, for example, include data relating to one or more aspects of business applications or databases. Operating environment layer data can, for example, include data relating to one or more aspects of operating systems, virtualized machines, containers, or clouds. Infrastructure layer data can, for example, include data relating to one or more aspects of server, storage, networking, or power management.

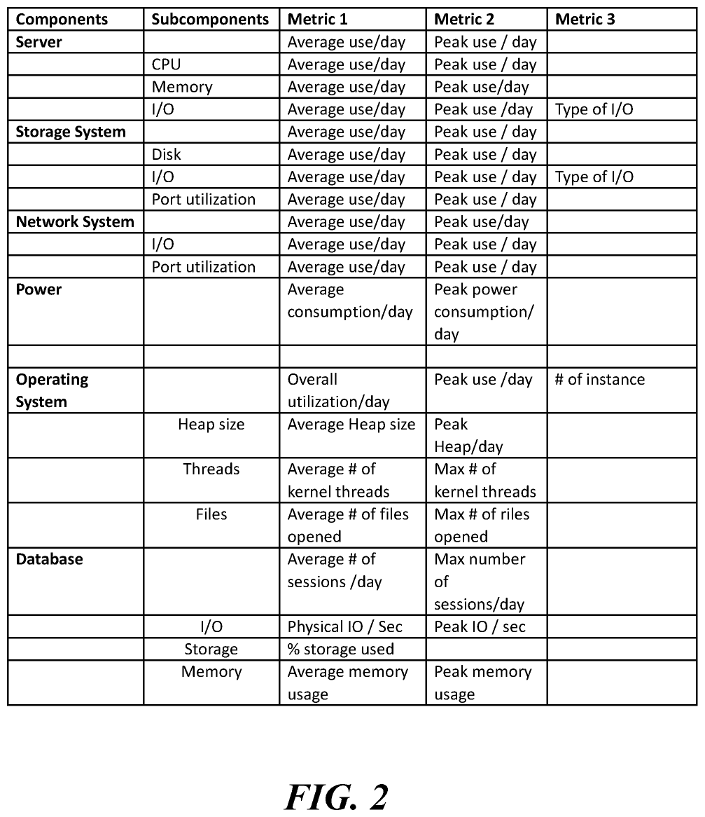

FIG. 2 is a table depicting example metrics for various components and subcomponents that can be tracked and used by certain implementations of the present disclosure. It is appreciated, that in some implementations, the collected operation data can include component level data, subcomponent level data, average daily use for components and subcomponents, and peak daily use for components, subcomponents, applications, virtual environment, or micro services. Such component level data can, for example, include data about one or more servers, storage systems, network systems, power systems, operating systems, and databases. Subcomponent level data can, for example, include data about one or more CPUs, memory, I/O, disk, port utilization, heap sizes, threads, and files.

It is appreciated that block 102 of collecting data can include collecting data from multiple systems or at the level of multiple data centers. In some implementations, data can be collected from multiple customers for similar products, which can then be used to train a model for customers with similar products and/or data center environments. In some implementations, the model can be applied at the data center level or a company-defined level (e.g., a company that defines edge equipment and core networking equipment as distinct subsystems).

Method 100 includes creating (at block 104) a supervised machine learning model based on the data collected in block 102. An example supervised machine learning model relying on the use of a cost function formula created by performing a gradient decent operation is described in detail below. However, it is appreciated that other suitable models may alternatively or additionally be used. In such an example, the model can be developed at the system level. However, the same or similar approach can be used to develop models at a subsystem level using subsystem subcomponents that can help identify potential issues, limits and remedies at the subsystem level. In some implementations, subsystem level output from the proposed model can feed into a system level matrix.

The sample matrix below shows attributes/properties (e.g., subsystem) and system level historical data that can be used to build a model:

| | Input x1 | Input x2 | Input x3 | Input x4 | Input x5 | Input x6 | Input x7 | System Y |
|---|---|---|---|---|---|---|---|---|
| s | Server | Storage | Network | DB | OS | DB | Apps | Utilization |
| (sample) | utilization | utilization | utilization | utilization | utilization | utilization | sessions | in t time |
| 1 | 10 | 10 | 10 | 10 | 10 | 10 | 10 | 15 |
| 2 | 10 | 20 | 30 | 10 | 10 | 10 | 10 | 18 |
| 3 | 5 | 20 | 30 | 10 | 10 | 10 | 10 | 12 |
| 4 | 90 | 20 | 80 | 10 | 40 | 30 | 90 | 130* |
| S | . . . | . . . | . . . | . . . | . . . | . . . | . . . | . . . |

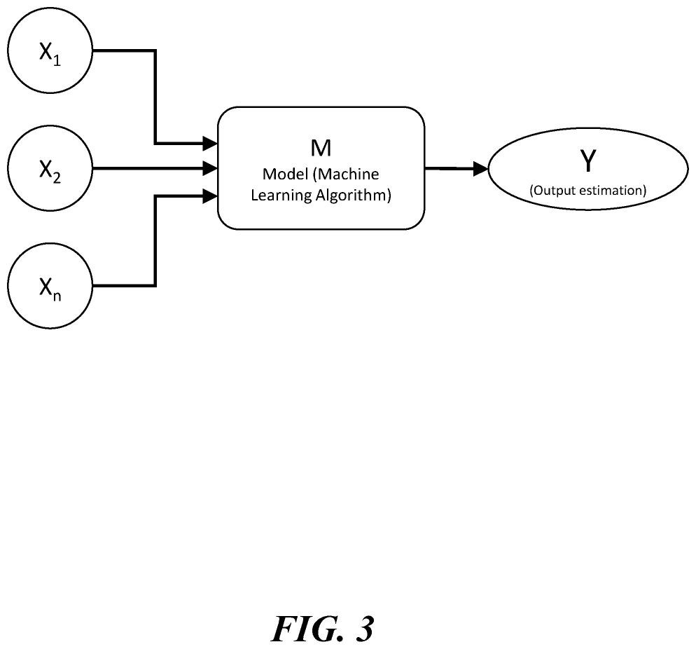

Per the above table, the system will be at 130% in next t period, which can indicate that the system is reaching its limit and may benefit from immediate attention (e.g. expansion, purchase, etc.). For purposes of description of an example method 100, the following definitions and assumptions are made:
X₁₋ᵥ=input variables, v is the number of variables. In this case it is 7.
s=number of samples
y₁₋ₛ=output; system level outcome 1 to s, corresponding to each sample set.
x₁₍ⱼ₎=input j's value for iₜₕ sample (example x₂⁽⁴⁾=20)
M=Supervised machine learning model, represented pictorially in FIG. 3

In some implementations, block 104 can develop a supervised machine learning model through the use of a linear regression technique with multiple variables. Such a model can, for example, be represented as:

M(x)=a+a₁(x₁) (note: a₁ and a are constants)

To account for multiple variables, a multiple variable linear regression formula can be provided:

M(x)=a₀+a₁(x₁)+a₂(x₂)+a₃(x₃)+a₄(x₄)+a₅(x₅)+a₆(x₆)+a₇(x₇)

Here aᵢ s are parameters to minimize the output error. To calculate aᵢ s and build the model such that prediction error and/or cost is minimized one can use a cost function and gradient decent, which is described in further detail below. In some implementations, cost can be defined as a difference between a predicted output and a real value, with the goal of the model being to minimize the cost. It is appreciated that in some implementations, polynomial regression or another suitable regression or approach may be used rather than linear regression.

As provided above, a cost function can be used to minimize prediction error and/or cost. Such a cost function a₀ . . . a₇ can be represented as:

$$C ( {a}_{0} , {a}_{1} … {a}_{7} ) = \frac{1}{s} {\sum }_{i - 1}^{s} ( {{M}_{a} ( {x}^{i} - {y}^{i} )}^{2}$$

The above equation can also be written as:

$$C ( a ) = \frac{1}{s} {\sum }_{i - 1}^{s} ( {{M}_{a} ( {x}^{i} - {y}^{i} )}^{2}$$

The above equations apply the following definitions:
s=total number of samples
x=inputs
y=outputs

As provided above, a gradient decent can be used to minimize prediction error and/or cost. Such a gradient decent operation can, for example, be used to determine the value of constants (a₀, a₁ . . . a₇) that will minimize prediction error and/or cost. Such a process and formula are defined as follows:

$${a}_{k} := {a}_{k} - β \frac{1}{s} {\sum }_{i = 1}^{s} ( {M}_{∅} ( {x}^{i} - {y}^{i } )$$

(note: here β is a constant for learning rate)
For each set of inputs (k=0 to v−number of variables) repeat the above step and simultaneously update value of aₖ.

Once the various aₖ values are known using the cost function and gradient decent algorithms, a model M can be used to predict the estimated system utilization next t time or other growth rate (e.g., for next 5 months) can be identified. For instance, assuming (a₀, . . . a₇)=(20, 0.1, 0.3, 0.5, 5, 2, 0.8, 0.7), then the final model will be:

M(x)=20+0.1(x₁)+0.3(x₂)+0.5(x₃)+5(x₄)+2(x₅)+0.8(x₆)+0.7(x₇)

In some implementations, a normal equation formula can be used to develop the model rather than a gradient decent. Such an implementation can, in some circumstances, be preferred when there is a limited number of variables (e.g. <1000), a powerful computing system for building the model, or in other suitable circumstances. Although a gradient decent approach can work for both smaller and larger sets of data, a normal equation may, in some circumstances be preferred for a smaller set of data.

Method 100 includes forecasting (at block 106) expected state, capacity, and growth rate of a system based on the model created at block 104. In some implementations, once the system's (or subsystem's) utilization, growth or potential issues are understood, the system can take intelligent action (see block 108 below). It is appreciated that block 106 can provide a forecast at least one month in the future, at least one year in the future, or another suitable time period. In some implementations, block 106 can include determining a failure date of the system based on the collected data, even if the failure date is beyond a predetermined time frame (e.g., one month, one year, etc.).

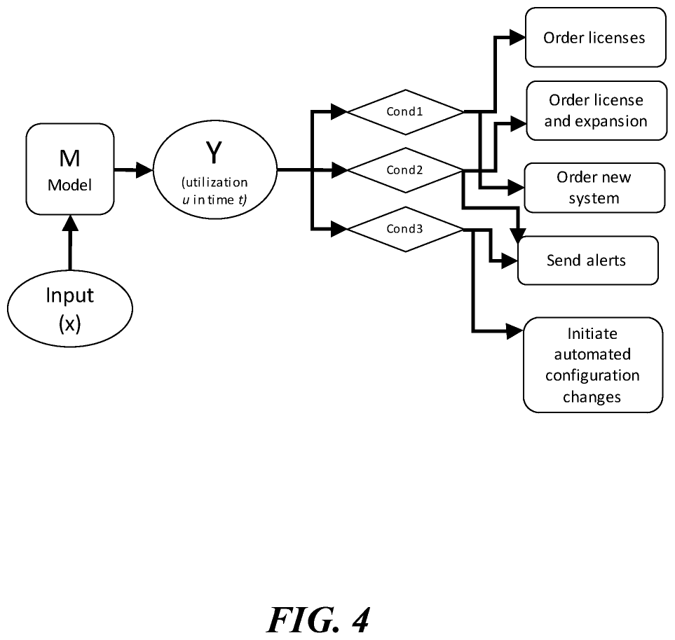

Method 100 includes performing (at block 108) an automated preemptive action based on the forecast of block 106. FIG. 4 provides a graphical depiction of method 100 including the performing operation of block 108. In some implementations, actions can include, ordering additional server, storage, and networking equipment for the data center. For example, if the model predicts that a system's utilization will be 173% in next 4 months, a process of additional system or expansion can be initiated automatically based on pre-defined criteria. By identifying potential bottlenecks and available suggestions, one can either remove the identified bottleneck or alleviate the problem by adding capacity or re-architecting the workload/system.

In some implementations, the model can provide suggested changes and identify new or expansion systems or components to be ordered from the vendor. In some implementations, an administrator can be presented with the models recommendation for approval and in some implementations the system can itself initiate and/or complete the process of ordering. In some implementations, performing an automated preemptive action includes automatically submitting an order for increased capacity for the data center. In some implementations, performing an automated preemptive action includes ordering licenses for equipment or software for the data center. In some implementations, performing an automated preemptive action includes initiating an automated configuration change by moving resources from one system to another. In some implementations, performing an automated preemptive action includes one or more of automatically submitting a request to re-architect a system in the data center, monitoring performance of the data center, and sending alerts. In some implementations, performing an automated preemptive action includes providing suggestions for changes to the data center. In some implementations, performing an automated preemptive action includes changing a configuration of a system component (or initiating process to move capacities from one block to other or from standby capacity), fixing a performance limit for a component, or another suitable action.

It is appreciated that one or more operations of method 100 can be performed periodically. For example, in some implementations, one or more of blocks 102, 104, 106, and 108 (or other operations described herein) may be performed periodically. In certain implementations of the present disclosure, certain operations (e.g., data collection and cost function calibration/adjustment, etc.) can be performed based on changes in environment or new information or additional set of data. The various period times for blocks 102, 104, 106, and 108 (or other operations described herein) may be the same or different times. For example, in some implementations, the period of block 102 is every 1 day and the period of block 104 is every 1 week. It is further appreciated, that the period for a given block may be regular (e.g., every day) or may be irregular (e.g., every day during a first condition, and every other day during a second condition). In some implementations, one or more of block 102, 104, 106, and 108 (or other operations described herein) may be non-periodic and may be triggered by some network or other event.

Although the flowchart of FIG. 1 shows a specific order of performance, it is appreciated that this order may be rearranged into another suitable order, may be executed concurrently or with partial concurrence, or a combination thereof. Likewise, suitable additional and/or comparable steps may be added to method 100 or other methods described herein in order to achieve the same or comparable functionality. In some implementations, one or more steps are omitted. For example, in some implementations, block 108 of performing an automated preemptive action can be omitted from method 100 or performed by a different device. It is appreciated that blocks corresponding to additional or alternative functionality of other implementations described herein can be incorporated in method 100. For example, blocks corresponding to the functionality of various aspects of implementations otherwise described herein can be incorporated in method 100 even if such functionality is not explicitly characterized herein as a block in method 100.

FIG. 5 is a diagram of a computing device 110 in accordance with the present disclosure. Computing device 110 can, for example, be in the form of a server, a controller, or another suitable computing device within a data center or in communication with a data center or equipment thereof. As described in further detail below, computing device 110 includes a processing resource 112 and a memory resource 114 that stores machine-readable instructions 116, 118, 120, and 122. For illustration, the description of computing device 110 makes reference to various other implementations described herein. However it is appreciated that computing device 110 can include additional, alternative, or fewer aspects, functionality, etc., than the implementations described elsewhere herein and is not intended to be limited by the related disclosure thereof.

Instructions 116 stored on memory resource 114 are, when executed by processing resource 112, to cause processing resource 112 to determine a cost function based on data regarding a data center's components including applications, operating environment, and infrastructure. Instructions 116 can incorporate one or more aspects of blocks of method 100 or another suitable aspect of other implementations described herein (and vice versa). For example, in some implementations, the operations of determining a cost function, applying a gradient decent model, and predicting an estimated data center component utilization relies on the use of a supervised machine learning model.

Instructions 118 stored on memory resource 114 are, when executed by processing resource 112, to cause processing resource 112 to apply a gradient decent model to minimize a cost for the data center based on the determined cost function. Instructions 118 can incorporate one or more aspects of blocks of method 100 or another suitable aspect of other implementations described herein (and vice versa).

Instructions 120 stored on memory resource 114 are, when executed by processing resource 112, to cause processing resource 112 to predict an estimated data center component utilization based on the applied gradient decent model. Instructions 120 can incorporate one or more aspects of blocks of method 100 or another suitable aspect of other implementations described herein (and vice versa).

Instructions 122 stored on memory resource 114 are, when executed by processing resource 112, to cause processing resource 112 to automatically order components for the data center based on the predicted data center component utilization. Instructions 122 can incorporate one or more aspects of blocks of method 100 or another suitable aspect of other implementations described herein (and vice versa).

Processing resource 112 of computing device 110 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 114, or suitable combinations thereof. In some implementations, processing resource 112 can be in the form of a Graphical Processing Unit (GPU), which is often used with machine learning and Artificial Intelligence. Processing resource 112 can, for example, include single or multiple cores on a chip, multiple cores across multiple chips, multiple cores across multiple devices, or suitable combinations thereof. Processing resource 112 can be functional to fetch, decode, and execute instructions as described herein. As an alternative or in addition to retrieving and executing instructions, processing resource 112 can, for example, include at least one integrated circuit (IC), other control logic, other electronic circuits, or suitable combination thereof that include a number of electronic components for performing the functionality of instructions stored on memory resource 114. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 112 can, for example, be implemented across multiple processing units and instructions may be implemented by different processing units in different areas of computing device 110.

Memory resource 114 of computing device 110 can, for example, be in the form of a non-transitory machine-readable storage medium, such as a suitable electronic, magnetic, optical, or other physical storage apparatus to contain or store information such as machine-readable instructions 116, 118, 120, and 122. Such instructions can be operative to perform one or more functions described herein, such as those described herein with respect to method 100 or other methods described herein. Memory resource 114 can, for example, be housed within the same housing as processing resource 112 for computing device 110, such as within a computing tower case for computing device 110 (in implementations where computing device 110 is housed within a computing tower case). In some implementations, memory resource 114 and processing resource 112 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 114 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 114 can be in communication with processing resource 112 via a communication link 124. Each communication link 124 can be local or remote to a machine (e.g., a computing device) associated with processing resource 112. Examples of a local communication link 124 can include an electronic bus internal to a machine (e.g., a computing device) where memory resource 114 is one of volatile, non-volatile, fixed, and/or removable storage medium in communication with processing resource 112 via the electronic bus.

In some implementations, computing device 110 can include a suitable communication module to allow networked communication between equipment. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware. The communication module can, for example, include machine-readable instructions for use with communication the communication module, such as firmware for implementing physical or virtual network ports. In some implementations, such a communication module can be used to interconnect multiple modules or processing units or to communicate the outcome or instruction or alert.

In some implementations, one or more aspects of computing device 110 can be in the form of functional modules that can, for example, be operative to execute one or more processes of instructions 116, 118, 120, and 122 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of computing device 110 can, for example, include one or more machine-readable storage mediums and one or more computer processors.

In view of the above, it is appreciated that the various instructions of computing device 110 described above can correspond to separate and/or combined functional modules. For example, instructions 116 can correspond to a “cost function determination module” to determine a cost function based on data regarding a data center's components including applications, operating environment, and infrastructure. Likewise, instructions 118 can correspond to a gradient decent module. It is further appreciated that a given module can be used for multiple functions. As but one example, in some implementations, a single module can be used to both determine a cost function and to apply a gradient decent model.

FIG. 6 illustrates a machine-readable storage medium 126 including various instructions that can be executed by a computer processor or other processing resource. In some implementations, medium 126 can be housed within a server, controller, or other suitable computing device within a data center or in local or remote wired or wireless data communication with a data center network environment. For illustration, the description of machine-readable storage medium 126 provided herein makes reference to various aspects of computing device 110 (e.g., processing resource 112) and other implementations of the disclosure (e.g., method 100). Although one or more aspects of computing device 110 (as well as instructions such as instructions 116, 118, 120, and 122) can be applied to or otherwise incorporated with medium 126, it is appreciated that in some implementations, medium 126 may be stored or housed separately from such a system. For example, in some implementations, medium 126 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 126 includes machine-readable instructions 128 stored thereon to cause processing resource 112 to collect operation data about a first data center, the first data including data at the application layer, the operating environment layer, and the infrastructure layer. Instructions 128 can, for example, incorporate one or more aspects of block 102 of method 100 or another suitable aspect of other implementations described herein (and vice versa). For example, in some implementations, the second data center is remote to the first data center and the received operation data is received over a network connection.

Medium 126 includes machine-readable instructions 130 stored thereon to cause processing resource 112 to receive operation data about a second data center, the second data including data at the application layer, the operating environment layer, and the infrastructure layer. Instructions 130 can, for example, incorporate one or more aspects of block 104 of method 100 or another suitable aspect of other implementations described herein (and vice versa).

Medium 126 includes machine-readable instructions 132 stored thereon to cause processing resource 112 to forecast expected state, capacity, and growth rate of a system based on the collected operation data and the received operation data. Instructions 132 can, for example, incorporate one or more aspects of block 106 of method 100 or another suitable aspect of other implementations described herein (and vice versa).

Medium 126 includes machine-readable instructions 134 stored thereon to cause processing resource 112 to perform automated intelligent action based on the forecast. Instructions 134 can, for example, incorporate one or more aspects of block 108 of method 100 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

1. A method comprising:
detecting one or more changes at a data center;
collecting operation data about the data center in response to detecting the one or more changes, the data including data at an application layer, an operating environment layer, and an infrastructure layer;
performing one or more regression operations on the collected data to create a supervised machine learning model;
determining a forecast of an expected state, capacity, and growth rate of the data center based on the created model; and
performing an automated preemptive action based on the forecast.

2. The method of claim 1, wherein the model performs a gradient descent operation on the collected data.

3. The method of claim 1, wherein the data at the application layer includes data relating to one or more aspects of business applications or databases.

4. The method of claim 1, wherein the data at the operating environment layer includes data relating to one or more aspects of operating systems, virtualized machines, containers, or clouds.

5. The method of claim 1, wherein the data at the infrastructure layer includes data relating to one or more aspects of server, storage, networking, or power management.

6. The method of claim 1, wherein the forecast is for at least one month in the future.

7. The method of claim 1, wherein the forecast is for at least one year in the future.

8. The method of claim 1, wherein performing the automated preemptive action includes automatically submitting an order for increased capacity for the data center.

9. The method of claim 1, wherein performing the automated preemptive action includes one or more of automatically submitting a request to re-architect a system in the data center, monitoring performance of the data center, and sending alerts.

10. The method of claim 1, wherein performing the automated preemptive action includes providing suggestions for changes to the data center.

11. The method of claim 1, wherein the collected operation data includes component level data, subcomponent level data, average daily use for components and subcomponents, and peak daily use for components, subcomponents, applications, virtual environment, or micro services.

12. The method of claim 11, wherein component level data includes data about one or more servers, storage systems, network systems, power systems, operating systems, and databases and wherein subcomponent level data includes data about one or more CPUs, memory, I/O, disk, port utilization, heap sizes, threads, and files.

13. A non-transitory machine readable storage medium having stored thereon machine readable instructions to cause a computer processor to:
detect one or more changes at a data center;
collect operation data about a first data center in response to detecting the one or more changes, the first data including data at an application layer, an operating environment layer, and an infrastructure layer;
perform one or more regression operations on the collected data to create a supervised machine learning model;
determine a forecast of an expected state, capacity, and growth rate of a system based on the model; and
perform automated intelligent action based on the forecast.

14. The medium of claim 13, wherein the second data center is remote to the first data center and the received operation data is received over a network connection.

15. A computing device comprising:
a processing resource; and
a memory resource storing machine readable instructions to cause the processing resource to:
detecting one or more changes at a data center;
collecting operation data about the data center in response to detecting the one or more changes, the data including data at an application layer, an operating environment layer, and an infrastructure layer;
performing one or more regression operations on the collected data to create a supervised machine learning model;
determining a forecast of an expected state, capacity, and growth rate of the data center based on the created model; and
performing an automated preemptive action based on the forecast.

16. The system of claim 15, wherein the model performs a gradient descent operation on the collected data.

17. The system of claim 15, wherein the data at the application layer includes data relating to one or more aspects of business applications or databases.

18. The system of claim 15, wherein the data at the operating environment layer includes data relating to one or more aspects of operating systems, virtualized machines, containers, or clouds.

19. The system of claim 15, wherein the processing resource further to determine a cost function to minimize a prediction error of the created model.

20. The system of claim 19, wherein the processing resource further to perform a gradient descent minimize a cost error generated by the cost function.
